(19) United States
(12) Patent Application Publication
(10) Pub. No.: US 2006/0266397 A1
(43) Pub. Date: Nov. 30, 2006

(54) Walking cane with mechanical and magnetic pick-up devices and illumination source

(76) Inventor: Andres A. Berl, Scarsdale, NY (US)

Correspondence Address: MILDE & HOFFBERG, LLP, 10 BANK STREET, SUITE 460, WHITE PLAINS, NY, 10606, US

(21) Appl. No.: 11/140,793

(22) Filed: May 31, 2005

(51) Int. Cl. A61H 3/02

(52) U.S. Cl. 135/70

(57) ABSTRACT

A walking cane having a handle having (a) a grasping device that is operable by a user with the same hand which holds the handle and (b) one or both of the following devices: (1) a light source, including a light control switch disposed on the handle, for illuminating a region near the distal end of the cane; and (2) a permanent magnet, preferably disposed on the handle, for attracting and holding objects which are made, at least in part, of magnetically permeable material.

### BACKGROUND OF THE INVENTION

The present invention relates to a walking cane for an ambulatory user provided with ancillary devices to assist the user in picking up items from the floor and for illuminating the user's path in the dark.

As used herein, the term “walking cane” is intended to mean any type of stick, tube, crutch, pole, rod or similar device which is used to assist in walking and/or maintaining balance while standing.

Many attempts have been made in the prior art to provide ambulatory assistance for the elderly and the handicapped. Walking canes have been provided with various accessories, such as devices to mechanically grasp and pick up objects from the floor. The following U.S. patents and published patent application disclose a large variety of such pick-up devices:

U.S. Pat. No. 3,763,872

U.S. Pat. No. 4,811,750

U.S. Pat. No. 5,392,800

U.S. Pat. No. 5,636,650

U.S. Pat. No. 6,386,216

U.S. Pat. No. 6,527,321

US 2004/0040588

These devices are adequate for the purpose for which they are intended, although none are particularly convenient to use. With some of these known walking canes two hands must be used to pick up an object: One hand to hold the handle of the walking cane and the other actuate the pick-up device to cause it to grasp the object. Particularly for an elderly person who may easily lose his/her balance, the use of both hands to pick up and retrieve an object is unsafe. With other known walking canes, the actuating mechanism for the pick-up device is difficult or awkward to control.

Furthermore, while these mechanical devices used with walking canes could easily grasp certain objects, such as items of clothing, it is difficult for them to retrieve small objects, such as keys, which may have been accidentally dropped.

It is also known in the prior art to provide a walking cane which can illuminate the region of the floor near the bottom of the cane. The following patents disclose various such illumination devices:

U.S. Pat. No. 4,062,371

U.S. Pat. No. 4,562,850

U.S. Pat. No. 4,625,742

U.S. Pat. No. 4,837,666

U.S. Pat. No. 5,197,501

U.S. Pat. No. 5,392,800

These patents all disclose a cane which incorporates a light, battery and switch combination that enables the user to illuminate his/her pathway when in a low light environment, such as at a cinema theater. Particularly persons of advanced age often have decreased night vision and require some extra illumination and assistance in a low light environment.

Finally, walking canes have been devised which incorporate various other mechanical and electrical devices. For example, U.S. Pat. No. 5,901,723 discloses a “security cane with pepper spray dispenser”. U.S. Pat. No. 4,583,080 discloses an “audible alarm and projection lamp attachment for a walking cane”. U.S. Pat. No. 4,280,204 discloses a “mobility cane for the blind, incorporating ultrasonic optical sensing apparatus”.

The art of walking canes has been developed over a period of many years, yet no cane has yet been produced which provides for the basic needs of a user without jeopardizing the safety of the user.

### SUMMARY OF THE INVENTION

It is a principal object of the present invention to provide a walking cane, incorporating a mechanical device for picking up articles, that is extremely easy to use with one hand, while leaving the other hand of the user free.

It is a further object of the present invention to provide a walking cane which is capable of picking up small metal articles.

It is a further object of the present invention to provide a walking cane with a built-in “flashlight” having a switch that is controlled by the user's cane-holding hand, leaving the user's other hand free.

These objects, as well as other objects which will become apparent from the discussion that follows, are achieved, in accordance with the present invention, by providing a walking cane, having (a) a grasping device that is operable by a user with the same hand which holds the handle, and (b) one or both of the following devices:

(1) a light source, including a light control switch disposed on the handle, for illuminating a region near the distal end of the cane; and

(2) a permanent magnet, preferably disposed on the handle, for attracting and holding objects which are made, at least in part, of magnetically permeable material.

Advantageously, the walking cane may also include a hook or loop to permit attachment of a carrying strap, or attachment of other items such as keys which the user may wish to keep handy.

The grasping device itself preferably comprises a plurality of grippers, formed as a plurality of wires having hooked ends which form a “claw” that is deployable between an open position disposed at the distal end of the walking cane and a closed position enclosed within this distal end. The claw is thus arranged for movement along the longitudinal axis of the cane, into and out of an opening at the distal end of the cane. The wires which form the claw are configured to spread apart when they are moved out of the opening and to collapse together when they are withdrawn within the distal end of the cane.

The grasping device is actuated by a rod that extends through the interior of the cane from its handle at the proximal end of the elongate cane tube to the claw at the distal end. A return spring biases the rod upward toward the proximal end in the direction of the handle thereby biasing the claw toward its closed position within the cane. A knob, which is disposed in, and protrudes upward from, the handle, is mechanically coupled to the upper end of the rod. This knob, and thus also the rod, may be pressed downward by the user to actuate the grasping device.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a perspective view of a walking cane according to the preferred embodiment of the present invention.

FIGS. 2A and 2B are schematic views of the grasping device, in the closed and open positions, respectively, which is incorporated into the walking cane of FIG. 1.

FIG. 3A is a schematic view of one preferred embodiment of an illumination device which may be incorporated into the walking cane of FIG. 1.

FIG. 3B is a schematic diagram of an alternative preferred embodiment of an illumination device which may be incorporated into the walking cane of FIG. 1.

FIGS. 4A and 4B are representative diagrams of the distal end of the walking cane of FIG. 1 with the grasping device in a closed position and in an open position, respectively.

FIG. 5 is a perspective view of the walking cane of FIG. 1, grasping an item of clothing.

FIGS. 6A and 6B are perspective views of a portion of the handle of the walking cane of FIG. 1 with a permanent magnet for picking up metal objects.

FIG. 7 is a perspective view showing an opposite end of the handle of the walking cane of FIG. 1, showing a loop for attachment of a carrying strap.

FIG. 8 is a detailed side view of the handle of the walking cane of FIG. 1 showing the position of the battery, the magnet, the loop, the illumination source and the knob for actuating the grasping device.

FIG. 9 is a cutaway view of the handle of FIG. 8.

### DESCRIPTION OF THE PREFERRED EMBODIMENTS

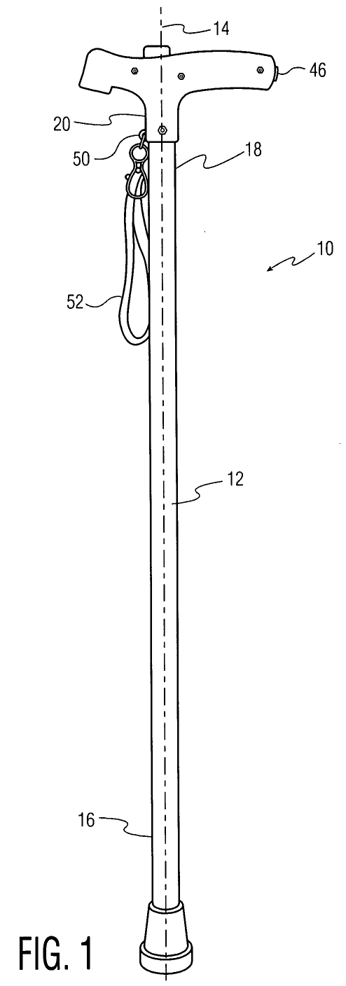

The preferred embodiments of the present invention will now be described with reference to FIGS. 1-9 of the drawings. Identical elements in the various figures are designated with the same reference numerals.

The walking cane 10 shown in FIG. 1 comprises a substantially linear elongate tube 12 having a longitudinal axis 14 and two ends forming a distal end 16 and a proximal end 18. A handle 20 is disposed and secured at the proximal end 18 of the tube 12.

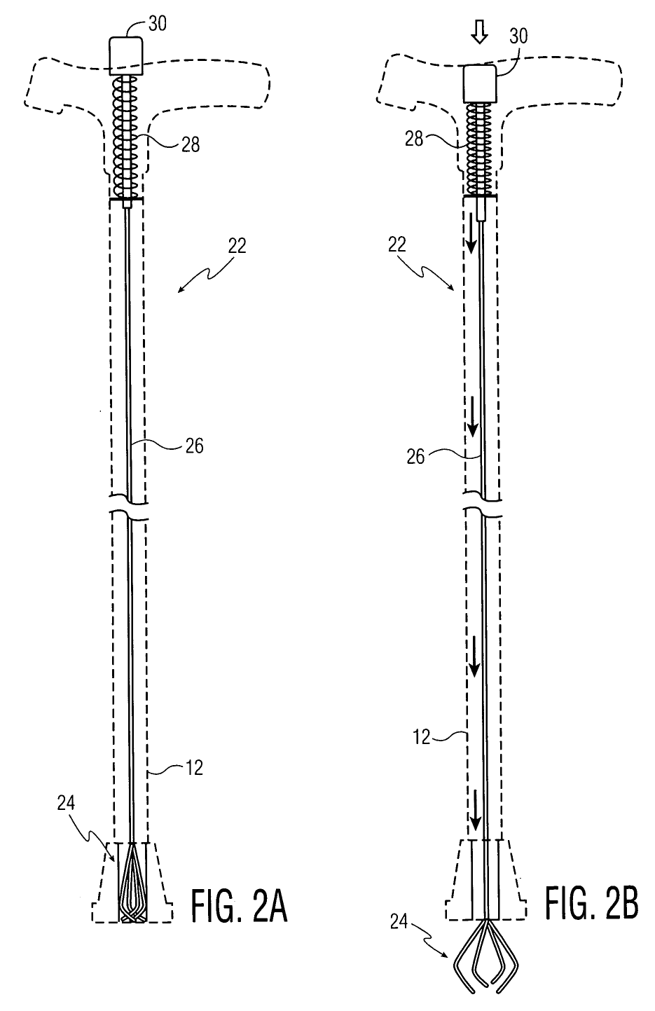

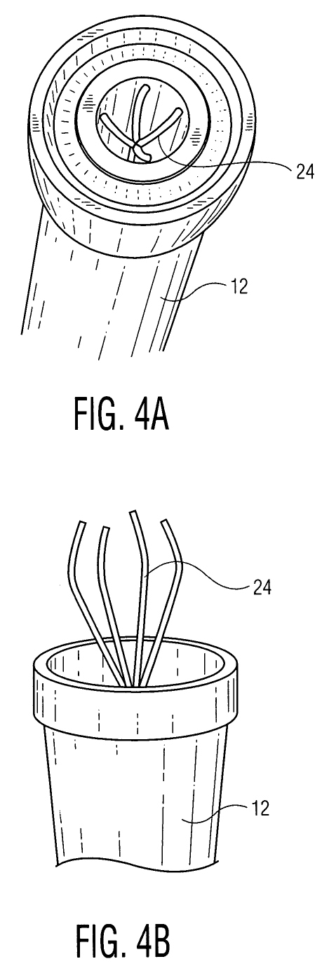

Incorporated inside the elongate tube 12 is an article grasping device 22 of the type shown in FIGS. 2A and 2B and FIGS. 4A and 4B. This device includes a claw 24 formed of a plurality of grippers having an open and a closed state. In particular, the claw is deployable between and open position (FIGS. 2B and 4B) exposed externally of the distal end 18 of the elongate tube 12 and a closed position (FIGS. 2A and 4A) in which the claw is enclosed within the elongate tube. As may be seen, the grippers comprise a plurality of wires which have hooked ends for gripping an object. The wires are configured to spread apart when they are moved out of the opening at the distal end of the tube, and are forced to draw together when they are withdrawn into the distal end of the tube.

The grasping device 22 further includes a rod 26 which extends through the interior of the elongate tube from the handle at the proximal end of the tube to the grasping device at the distal end.

In addition, the grasping device includes a return spring 28 for biasing the rod toward the proximal end of the tube in the direction of the handle, thereby to bias the grasping device toward its closed position within the distal end of the tube.

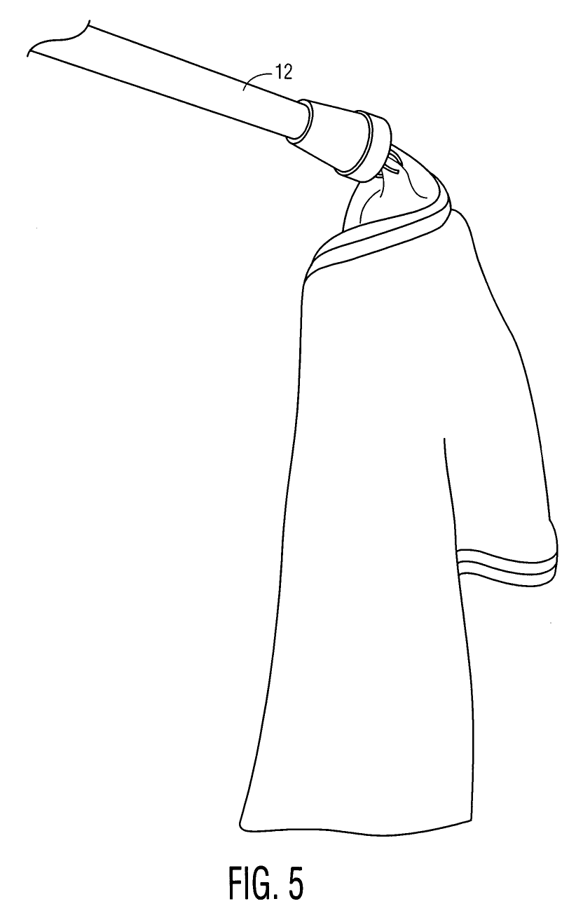

Finally, the grasping device includes a knob 30, coupled to the proximal end of the rod 26 for actuation by the user. By pressing down on the knob 30, and forcing the rod 26 downward in opposition to the force of the spring 28, the claw 24 is pressed out of the distal end of the tube 12 and allowed to open into a position for grasping an object, such as an item of clothing. Thereafter, upon releasing the knob 30, the spring 28 returns the rod and the claw to the upper and closed position, thus grasping an object in the manner shown in FIG. 5.

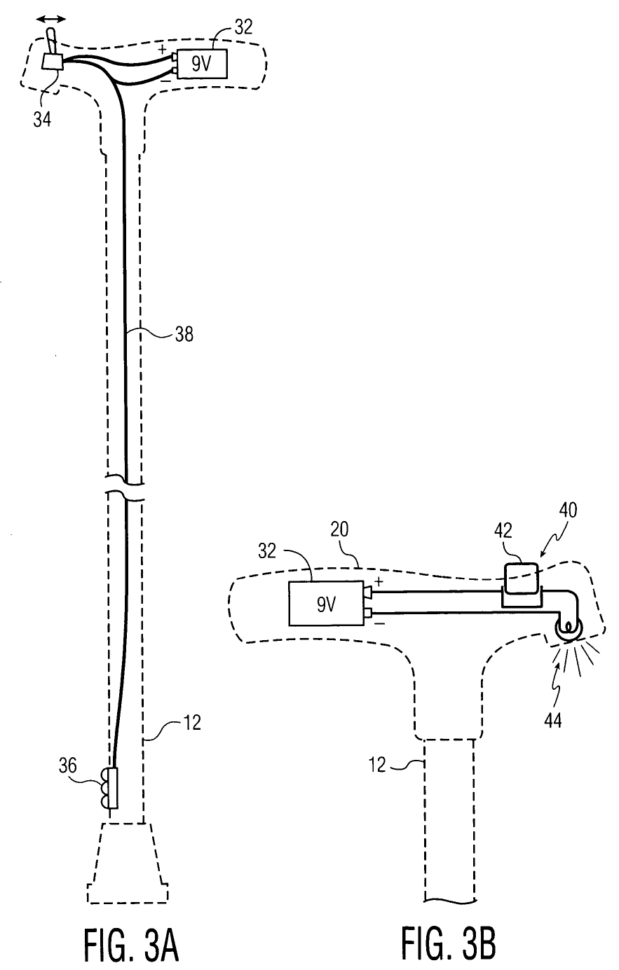

FIGS. 3A and 3B show two different embodiments of an illumination source which may be incorporated into the walking cane according to the present invention. In the device shown in FIG. 3A, a battery 32 is coupled through an on/off switch 34 to provide electrical power to LEDs 36 arranged at the distal end of the tube 12. In this embodiment, a pair of wires 38 extends from the handle through the interior of the tube 12 to the LEDs 36.

In the embodiment shown in FIG. 3B, the illumination source is incorporated entirely within the handle 20 of the walking cane. In this case, the on/off switch 40 is actuated by a push button 42 and, together with the battery 32, provides power to a light source or lamp 44. The light source 44 preferably comprises on or more LED's, which require low power, but may also be another type of electric light, such as an incandescent lamp.

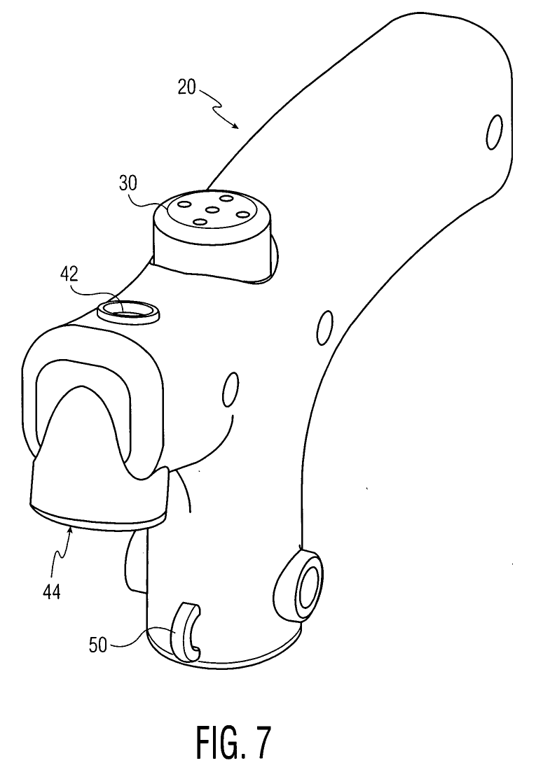

FIGS. 7-9, which show the handle 20 in detail, illustrate the relative positions of the battery 32, push button 42 and light source 44.

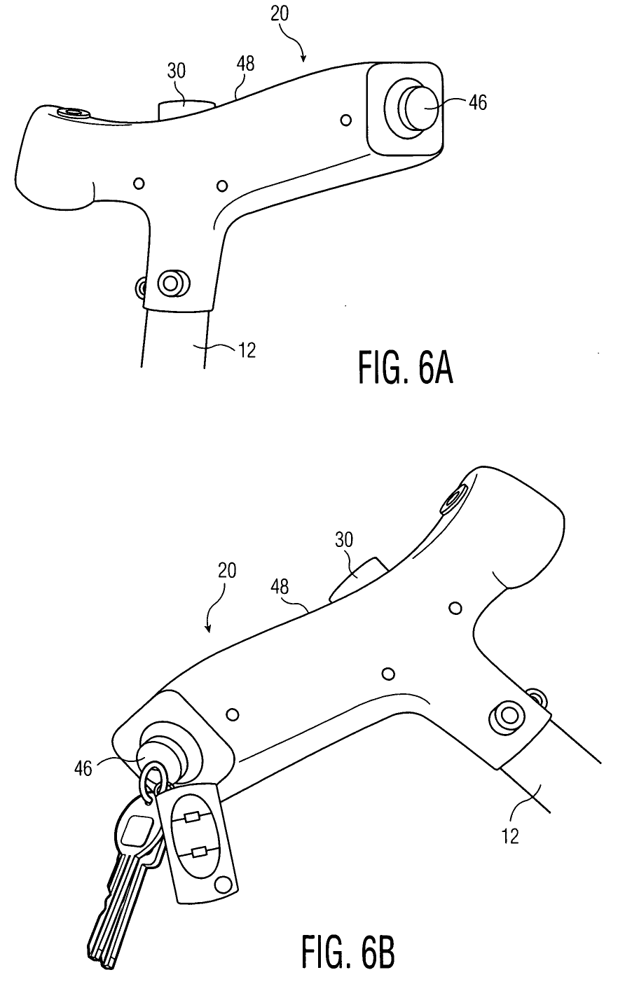

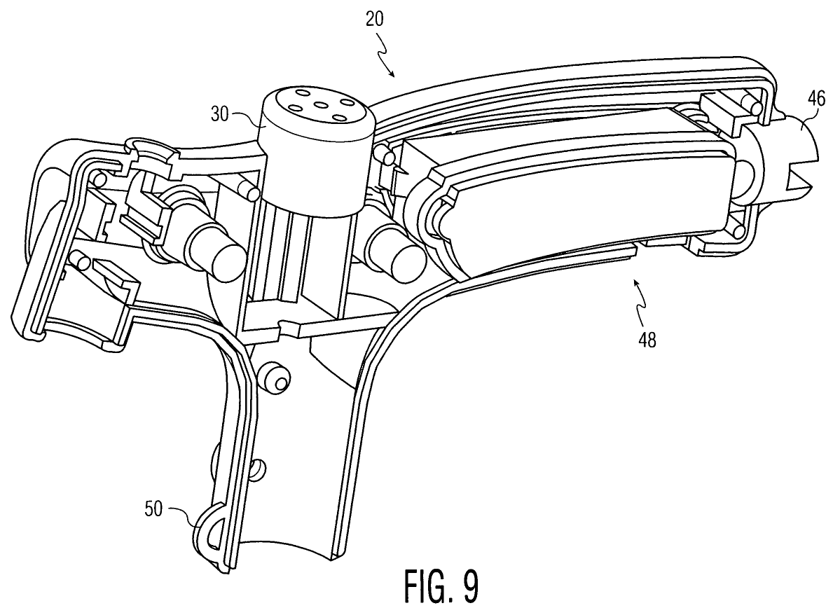

Conveniently, the handle 20 is further provided with a permanent magnet 46 for attracting and holding objects that are made, at least in part, of magnetically permeable material such as iron or steel. This magnet 46 is arranged at the tip of a protruding portion 48 of the handle 20 so that the magnet may attract and thereafter make contact with the metal object when the protruding portion is placed in the vicinity of the object. The arrangement of the magnet 46 on the handle 20 is best seen in FIG. 6A and FIG. 9. FIG. 6B shows how the magnet is used to pick up a metal object.

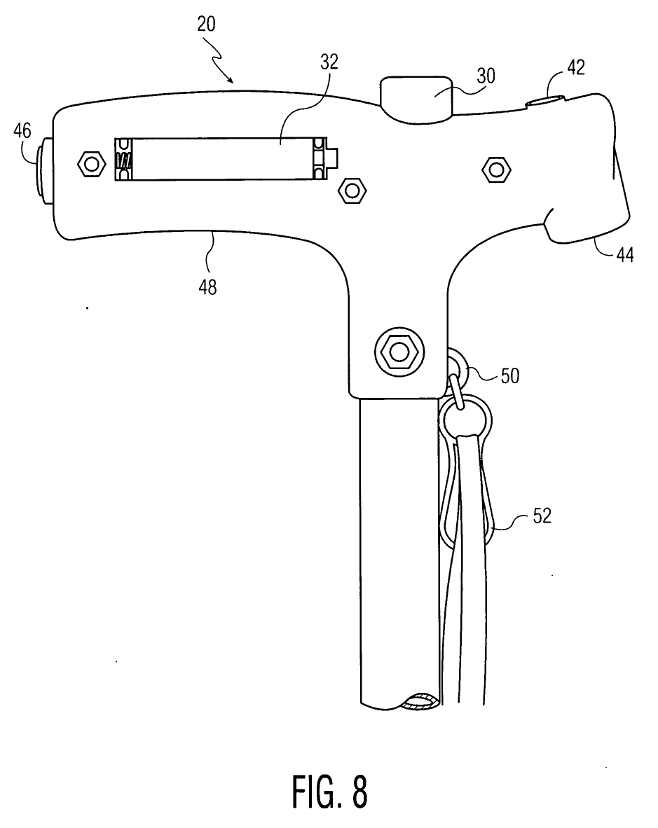

Finally, as is best illustrated in FIGS. 7 and 8, the handle 20 may be provided at its base with a loop 50 or similar device for attachment of a carrying strap 52 or the like.

There has thus been shown and described a novel walking cane with mechanical and magnetic pickup devices and illumination source which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A walking cane comprising:
(a) a substantially linear elongate tube having a longitudinal axis and two ends forming a distal end and a proximal end;
(b) a handle disposed at and secured to the proximal end of the elongate tube;
(c) an article grasping device disposed at the distal end of the elongate tube, said grasping device including at least three gripper prongs having open and closed states and being deployable between (1) an open position exposed externally of the elongate tube at the distal end, and (2) a closed position enclosed within the elongate tube;
(d) an operating device, disposed in the elongate member and extending from said handle at said proximal end to said grasping device at said distal end, responsive to actuation at the handle by a user for moving the gripper prongs of the grasping device between said open position and said closed position;
(e) a light source, including a light control switch disposed on the handle and responsive to actuation by said user, for illuminating a region near said distal end of said elongate member; and
(f) a permanent magnet arranged on said handle for attracting and holding objects which are made, at least in part, of magnetically permeable material.

2. (canceled)

3. The device defined in claim 2, wherein said handle includes a protruding portion, and wherein said magnet is disposed on said protruding portion.

4. The device defined in claim 1, further comprising loop means for attachment of a carrying strap.

5. The device defined in claim 4, wherein said loop means is disposed on said handle, adjacent to its point of attachment with the proximal end of the elongate member.

6. The device defined in claim 1, wherein said gripper prongs each comprise a wire having a hooked end.

7. The device defined in claim 6, wherein said gripper prongs are arranged for movement along said longitudinal axis into and out of an opening at the distal end of the elongate tube.

8. The device defined in claim 7, wherein said gripper prongs are configured to spread apart when they are moved out of said opening.

9. The device defined in claim 1, wherein said operating device includes a rod, extending through the interior of said elongate tube from said handle at said proximal end to said grasping device at said distal end, for actuating said grasping device.

10. The device defined in claim 9, wherein said operating device further includes a return spring for biasing said rod toward said proximal end in the direction of said handle, thereby to bias said grasping device toward said closed position within the elongate tube.

11. The device defined in claim 9, wherein said operating device further includes a knob disposed at the end of said rod for actuation by the user.

12. The device defined in claim 11, wherein said knob is disposed in and protrudes upward from said handle, whereby said knob may be pressed downward by the user to actuate said grasping device.

13.-23. (canceled)

24. The device defined in claim 1, wherein the light source is disposed in said handle.

25. The device defined in claim 1, wherein the grasping device includes four gripper prongs arranged substantially equidistant from each other.
